(19) United States
(12) Patent Application Publication
(10) Pub. No.: US 2023/0328189 A1
(43) Pub. Date: Oct. 12, 2023

(54) Defined interface between the Print Unit and Print Array Host to enable a Production Network

(71) Applicant: INDUSTRY SUPPLIES, INC., Newark, DE (US)

(72) Inventor: Martin D. Fiumura, Buenos Aires (AR)

(21) Appl. No.: 18/297,045

(22) Filed: Apr. 7, 2023

Related U.S. Application Data
(60) Provisional application No. 63/328,566, filed on Apr. 7, 2022.

(51) Int. Cl. H04N 1/00; B29C 64/393; B29C 64/20; H04N 1/327; B33Y 30/00

(52) U.S. Cl. CPC H04N 1/00538; B29C 64/393; B29C 64/20; H04N 1/32789; B33Y 30/00

(57) ABSTRACT

Method, system, and apparatus for a Production Network used in Additive Manufacturing and, more particularly, a modular Print Array of additive manufacturing Print Units having modular physical, electrical, and logic interfaces to enable a Production Network with no downtime thanks to interchangeable sets of modules and centralized control.

### FIELD OF THE INVENTION

This invention relates to a 3D additive manufacturing system's Array. The Print Array architecture is devised to support and manage scalable part production by deploying a modular interface between the Print Array Host and the Print Unit modules.

### BACKGROUND OF THE INVENTION

Over the decades, additive manufacturing (AM) has matured into a reliable technology with a great variety of equipment and advanced software options. Faster machines, better materials, and smarter software are helping to make AM a realistic solution for many real-world production applications. As processes have matured and materials science has accelerated, additive manufacturing is now used throughout the full production cycle complementing traditional manufacturing processes.

AM technology is now proven, well-understood and established as a manufacturing method across many industry sectors. The key standards have been developed, enabling repeatable quality at scale. AM systems offer several benefits, including increased flexibility, independence, as well as time and cost savings.

Industrial 3D printing systems have been developed as complex technical equipment, which requires technical training to develop practical operation and maintenance skills. Taking into consideration the organization's need for early-stage adoption and scalability, the present invention aims at making more efficient operation, maintenance, technical services to 3D printing systems so to reduce downtime, and thus maintenance and training costs.

The main obstacle preventing the adoption of 3D printers into an industrial manufacturing process is the lack of a workflow from prototyping to scalable production. In fact, companies use 3D printers as stand-alone equipment in which they prototype and also manufacture the final parts they need in low volume batches. A target company may purchase a few units to cover the production needs by operating each unit individually.

On one side, the R&D team requires the agility to iterate prototypes and finalize the design for each component. On the other side, the procurement team has to develop the supply chain, and thus determine whether to convert the designs onto another manufacturing process (with great cost and lead time) or, if manufacturing with 3D printers is possible for that application, to purchase more 3D printers to meet the production needs. No 3D printer product line offers a real solution to solve both the needs of the R&D team and those of procurement.

Providing a path to an additive manufacturing Production Network requires hardware, electronics, control protocols and software. This patent covers the interface between the Print Array Host and the Print Unit modules.

### SUMMARY OF THE INVENTION

Process development is based on the system architecture of the 3D printer being used. The critical machine elements are the XY motion system, hotend, nozzle geometry, filament drive system, chamber heating, and filament drying. Related variables material type and size are either determined by the machine requirements.

The current state-of-the-art Stratasys FDM systems are typical. On one hand, the F370 prototyping system is based on MakerBot technology, has limited materials, and is priced for departmental use at less than $50,000. On the other hand, their industrial model Fortus 450MC is based on older Stratasys technology and has a more extensive range of materials and is priced at around $160,000-220,000.

The issue with the use of these machines is that they share very little in architecture; like they were created by different companies. An engineer creating functional prototypes on the F370 has to redo that development effort on the production machine to scale.

These are all impediments to the creation of a true digital workflow. The node-based 3D printing is a structural difference, that requires a new control protocol and results in a network-based production: the Production Network.

Interoperability at this level enables not just distributed control of a machine, but distributed production.

The interface design from the Print Array Host to the Print Unit is both unique and protectable. The separation of control electronics makes these modular and interchangeable. The swappable and interchangeable architecture forces a separation of the Print Unit and control electronics. This will increase economies of scale and help create a de facto standard. The common logical interface enforced this way also opens up generic APIs to address and control network printers.

The interface between the Print Unit and the Print Array Host controls are well defined so that other Print Unit types could include both additive, traditional manufacturing, inspection, and scanning technologies.

This marketplace for Print Unit modules creates a Production Network and the network marketing effect.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 is a perspective view of a Single Print Unit for prototyping in accordance with the present invention.

FIG. 2 is a perspective view of a Print Array unit featuring one-to-one matchup of Electronics Module (2) to Print Unit (1) and Feeding and Drying Module (3) in accordance with the present invention.

FIG. 3 is a perspective view of a motion module of a Single Print Unit (FIG. 1) without outer panels, featuring the integrated Electronics Module (4) in accordance with the present invention.

FIG. 4 is a perspective view of a Print Unit Module of a Print Array (FIG. 2), featuring an electrical keying fast-locking connector at the end of the cabling bundle (5) in accordance with the present invention.

FIG. 5 is a perspective view of Print Array Host showing a set of modules comprising a Print Unit (6), an Electronics Module (7), and a Feeding and Drying Module (8) sliding in, in accordance with the present invention.

FIG. 6 is a lateral view of an Electronics Module without lateral panel showing the electronics architecture, including a Control Hardware Mainboard (CHM) (10), a Single Board Computer (SBC) (9), a Built-In Power Supply (11), a keying electrical connector (12) in accordance with the present invention.

FIG. 7a is a perspective front view of an Electronics Modules featuring a handle (16), a power button (17), and a display (18).

FIG. 7b is a perspective rear view of an Electronics Modules featuring a power plug (14), and an industrial 108-pin connector (15).

FIG. 8 is a perspective front view of a Print Unit and it associated Electronics Module within the Print Array Host.

FIG. 9a is a perspective view of a Print Unit components including the XY motion system (24), filament drive system, chamber heating system (20), Z motion system (21), air-flow system (23), and insulation (19).

FIG. 9b is a front view of a Print Unit components including the XY motion system (24), hotends (25), nozzle geometry (25), filament drive system, chamber heating system (20), build platform (22), and air-flow system (23), in accordance with the present invention.

FIG. 10 is a perspective bottom view of a Print Unit showing the four keying elements (26) designed to fit and slide into T-slotted aluminum profiles in accordance with the present invention.

FIG. 11. is a front view of a Print Unit adjacent to an Electronics Module featuring keying elements fitting into the T-slotted aluminum profiles (27) and the display on the Electronics Module (28) on the Print Array structure in accordance with the present invention.

FIG. 12 is a perspective view of blocking clamps on the Print Array T-slotted aluminum profiles securing the Print Unit to the Print Array Host interface in accordance with the present invention.

FIG. 13 is a perspective schematic view of a Feeding System up to the extruders (32) in the Print Array Host featuring electronics (30), a Drying Module (29), and 2 Buffers (31), in accordance with the present invention.

FIG. 14 is a perspective view of a Print Array Host featuring an internal CPU (34) and a Router (35) in accordance with the present invention.

### DETAILED DESCRIPTION OF THE INVENTION

### Definitions

| | |
|---|---|
| PU or Print Unit | Print Unit or the modular 3D printing module. |
| | Also, a measure of production capacity (e.g. |
| | a Prototyping Unit = one PU; a Production |
| | Machine = 4 PUs) |
| SPU or Single Print Unit | Prototyping Unit |
| PA or Print Array | Production Machine or PM |
| PAH or Print Array Host | Empty Production Machine, no PUs or EMs |
| EM | Electronics Module |
| PN | Production Network or network that these |
| | various print capabilities use for |
| | communications and control |
| Node | A generic print node connected a Prototyping |
| | Unit or Production Machine attached to a |
| | Production Network |
| DRM | Digital Rights Management |
| Control CPU | Central non-real-time controller that manages |
| | a PA. SPUs do not have a Control CPU. |

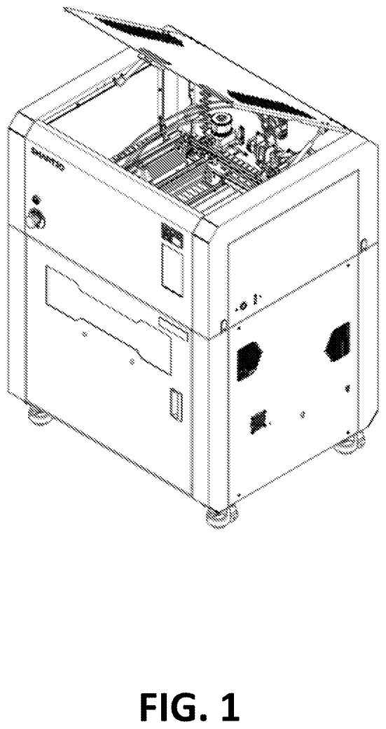

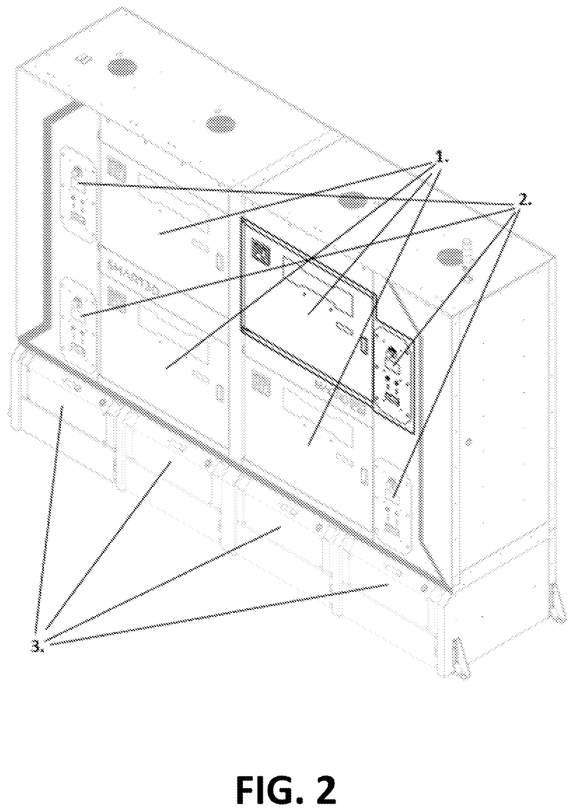

The systems of the present invention were designed for different users, spaces and applications for additive manufacturing. The Single Print Unit (FIG. 1) (SPU) is a prototyping machine to be used by a designer or engineer at an office to rapidly iterate on the different stages of product development. The Print Array (FIG. 2) (Production Machine), on the other hand, is a production machine meant for the manufacturing of tools, fixtures and end-use parts, among others, typically on the factory floor.

These users and setups have different needs. While a designer at an office may see material drying, print queuing, on-screen slicing, automatic material backup and others as “nice-to-have” features, for a production engineer running a batch of hundreds or thousands of parts at a factory they significantly lower labor, downtime, and risk of failure.

For prototyping and first adoption, Single Print Unit (FIG. 1) is a self-standing equipment. The Print Array system (FIG. 2) is a fundamental structure populated with interchangeable modules. In the present invention, Production Machines (PM) are Print Array (FIG. 2) systems in 2×2 or larger arrays of Print Units (FIG. 4) (PU), to provide consistent, scalable motion and print control.

The novelty of the present patent is the modular structure of the Print Unit (FIG. 4) and Print Array (FIG. 2) product line. More specifically, the comprehensive integrated interface of the Single Print Unit (FIG. 1) and the Print Array (FIG. 2) product lines, and the high degree of redundancy built into the Production Machine (FIG. 2). The new technical modular system of the present invention enables a Production Network using a unique interface architecture. The Print Array system (FIG. 2) is a fundamental structure populated with modules. The modular architecture gives redundancy to the Production Machine (FIG. 2) in case of failure of one or more modules.

The design of the Print Array control architecture enables remote use and control of a mass installation of Print Unit capacity. The core of the Production Network relies on unique multi-level electronics architecture. The distributed control allows maximum flexibility to manage both additive and traditional manufacturing technologies.

In the preferred embodiment of the present invention, Fused Filament Fabrication (FFF) is the 3D printing technology deployed. In another embodiment, interchangeable modules can include all types of additive manufacturing equipment, as well as traditional manufacturing, inspection and scanning technologies.

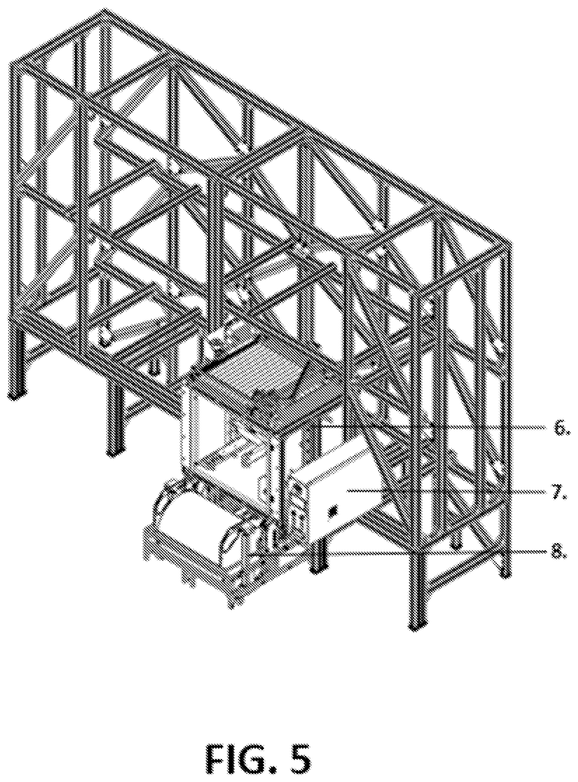

Production Machines consist of a sturdy aluminum framing structure (FIG. 5), which contains 2×2 modular sets (FIG. 2). These sets are composed by one Print Unit module (6), one Electronics Module (7), and one Feeding and Drying Module (8). In another embodiment of the present invention, according to the technology deployed, the Production Machine (FIG. 2) can house other ancillary equipment modules, such as annealing systems, vacuum systems, ultrasonic resin cleaner, support removal systems.

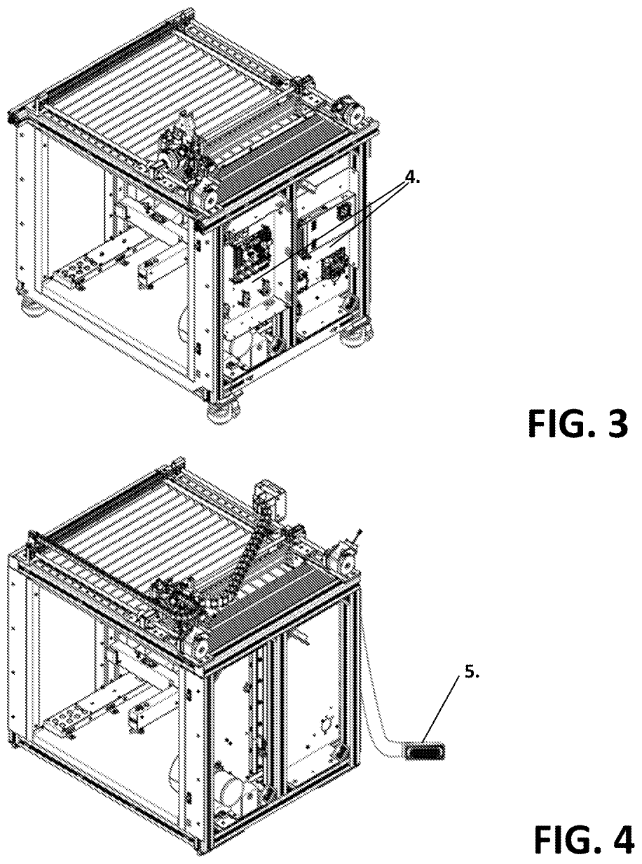

The design of the motion module is used both in the Single Print Units (FIG. 3) model for prototyping and in the Print Array (FIG. 4) product line. Single Print Units (FIG. 1) share the same motion configuration with Print Unit elements within the Production Machine (FIG. 2). In the Print Array (FIG. 2), said motion configuration is arranged in elements (FIG. 4) which are modular and interchangeable.

Single Print Units (FIG. 1) are tools for designers and engineers working on different phases in the product life-cycle, such as product development, design iterations, process optimization, material testing and validation, development and production of manufacturing aids, and spare parts, among others. They enable the creation of a digital inventory, which is the source used at the factory to efficiently select, automate and scale a production process within common material settings and configurations.

These Single Print Units (FIG. 1) are low-cost devices which accelerate the production of each iteration of a prototype, avoid the need for outsourcing with their external quoting requirements and supply chain bottlenecks, reduce lead times, and make every part they process ready for internal production and scale.

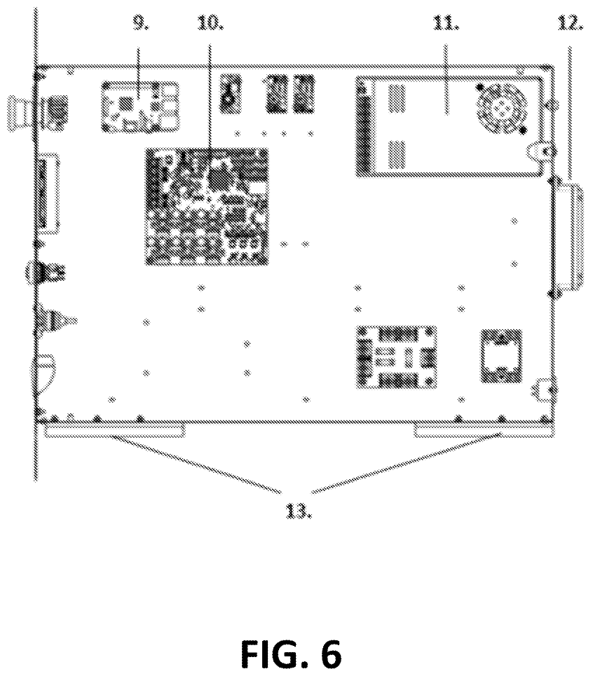

Single Print Units have an integrated electronics architecture (4) which is not removable. Single Print Units (FIG. 1) share the same electronics configuration with each Print Unit within the Print Array. The same design of the Electronics Module is used both in the Single Print Units (4) model used for prototyping and in the Electronics Module (FIG. 6) powering the Print Unit (FIG. 4) for the Print Array (FIG. 2) product line for production floors.

Single Print Units (FIG. 1) may be a simplified version of the Print Units (4) in Production Machines (FIG. 2). Their core architecture does not differ to ensure that material compatibility, precision, and speed need are identical for a transparent transition from prototyping to production. But ancillary features such as material drying, automatic feeding, material backup, Print Unit management, or the facilitated replacement and modularity of Print Units and Electronics Modules are not required, favoring lower capital investments in the product validation phases of the product lifecycle.

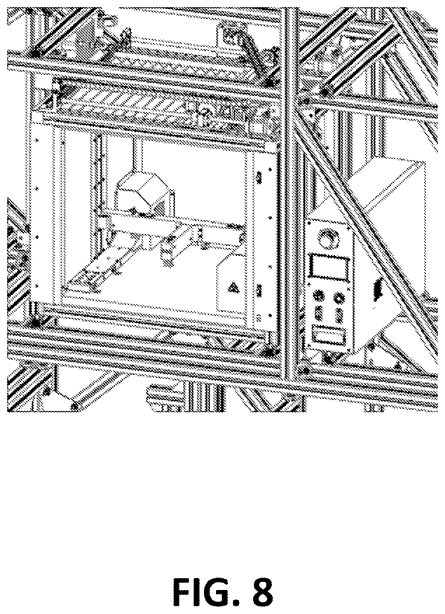

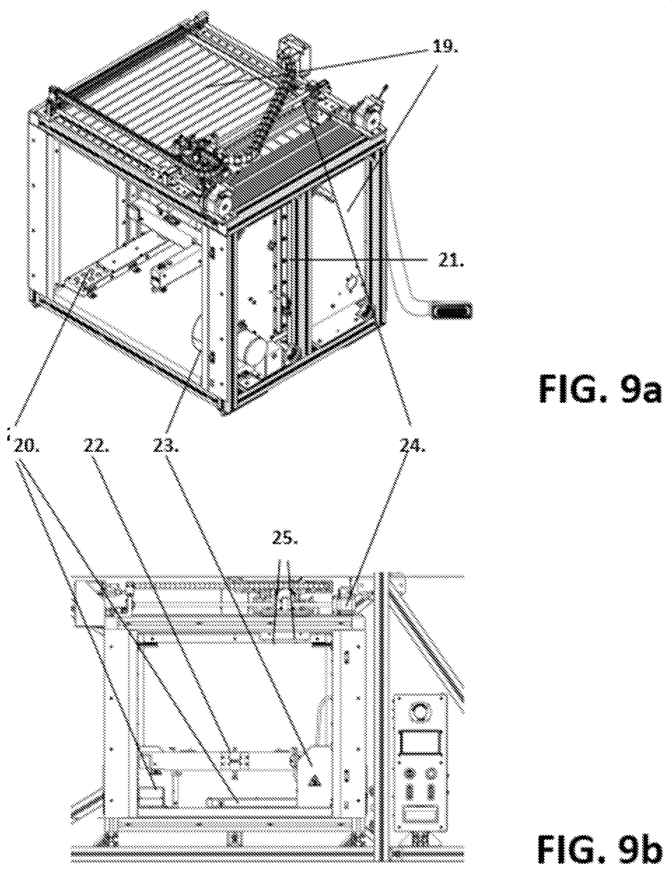

Each Print Unit (FIG. 4) in the Print Array (FIG. 2) can feature different characteristics in any combination, such as extrusion and chamber temperature, or single or dual extrusion for printing a greater variety of engineering or high-performance polymers. Each Print Unit (1) in the Print Array (FIG. 2) has an Electronics Module (2) arranged next to the individual Print Unit (FIG. 8), which supports any combination of such characteristics. Both Print Units (1) and Electronics Modules (2) are easily swappable modules for maintenance or technical service.

The present invention enables a Production Network for additive manufacturing technologies using a unique interface architecture based on Hardware, Electronics, Control Architecture, and Software. The designs to make these modules interchangeable are a fundamental enabler of the Production Network. Said architecture encompasses a unique physical, electrical, and logical interface.

### Physical Interface

In the preferred embodiment of the present invention, a Print Unit consists of a sturdy aluminum framing structure (FIG. 4) containing the whole motion system and 3D printing elements of a Prototyping Unit. This includes, among others, the XY motion system (19), hotends (25), nozzle geometry (25), filament drive system, chamber heating system (20), build platform (22), Z motion system (21), air-flow system (23), and insulation (19). It can also include, among others, direct extrusion system, any relevant sensor, and fiber, liquid or gas, or any other kind of material application system. For instance, being insulation (19) a part of Print Modules (FIG. 4) and not the Print Array Host (FIG. 5), Print Modules with high temperature capabilities can be mixed in arrayed systems.

The Print Unit (FIG. 4) module presents a compact XYZ motion system fitting within the frame of the motion unit. The Print Unit element has been sized to be easily removed through the existing 2×2 doors (1) of the Print Array Host (FIG. 5). In fact, modular Print Unit (FIG. 4) elements are loaded through the same door (1) at printing access. Serviceability is improved by including all wear items in the module.

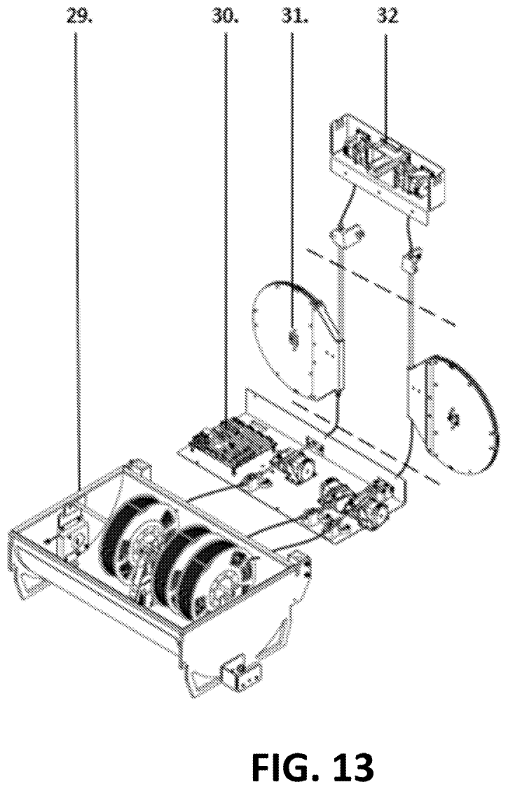

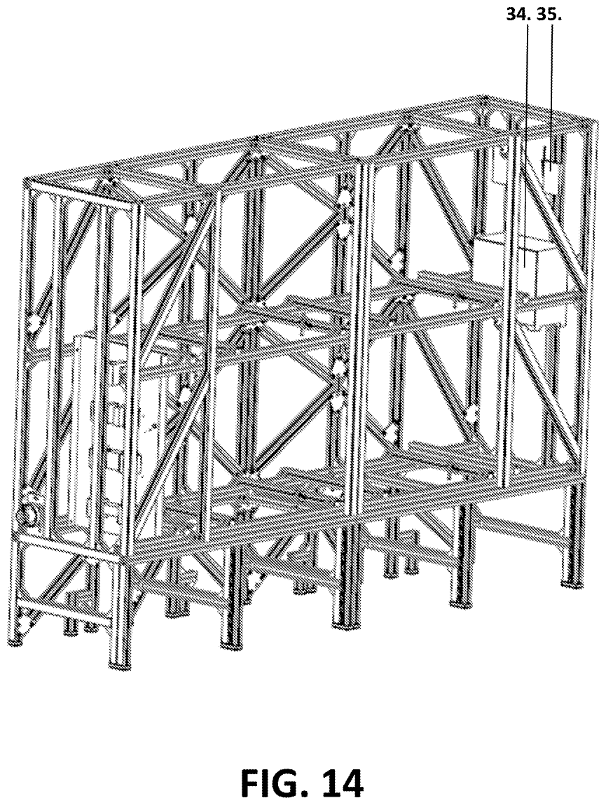

Each Print Unit (FIG. 4) module is equipped with a sliding mounting system (FIG. 5) with blocking clamps (FIG. 14) on the Print Array Host. In the preferred embodiment of the present invention, the sliding mounting system consists of four keying elements (26) which fit into T-slotted aluminum profiles (FIG. 2), allowing modules to slide in and out with ease (FIG. 5). Blocking clamps (FIG. 13) can include screw clamps, spring clamps, strap clamps, bench clamps, or any other means to secure each module to the Print Array structure for security purposes.

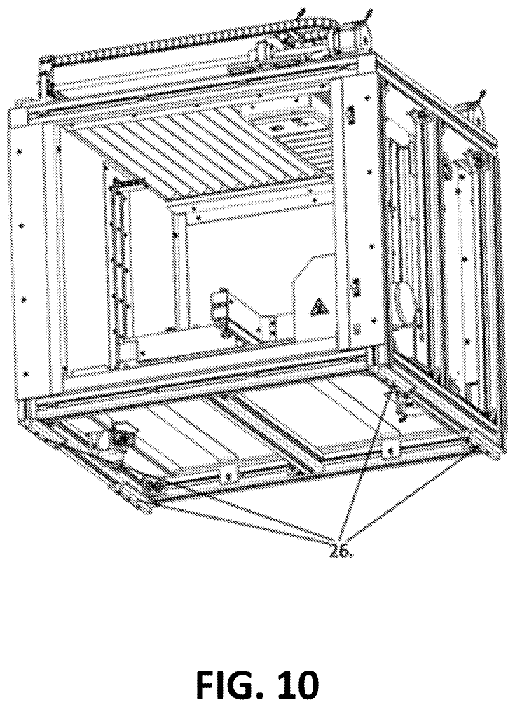

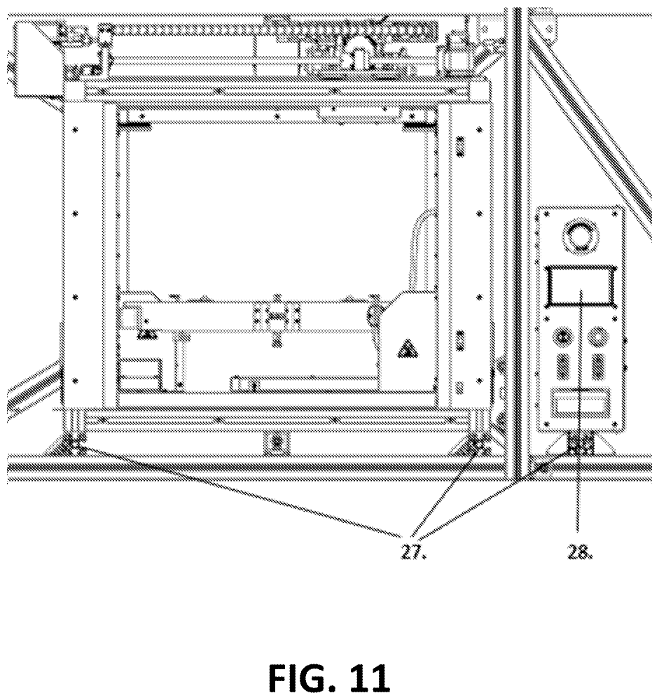

The Print Units' sliding mounting systems (FIG. 10) allow PUs (FIG. 4) to be easily swapped within minutes. When a Print Unit (FIG. 4) requires maintenance, the module is removed from the Print Array together with its offset and calibration data stored in a dedicated SD card in the Electronics Module. This reduces production downtime by rapidly replacing a unit needing maintenance with another one ready for service with its offset and calibration data.

Each Print Unit in the Print Array has an Electronics Module located in proximate distance (FIG. 8), which supports all variations and combinations of Print Unit features. Each Electronics Module controls only the Print Unit to which it is associated and physically connected via an electrical connector (5, 12, 15). The Electronics Module's local computer power resources are only for print control of the Print Unit it is associated with.

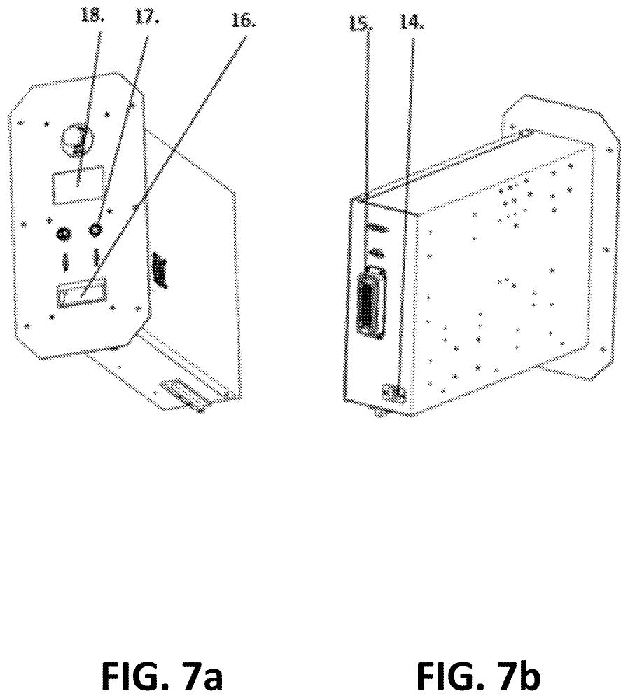

Electronics Modules (2) in the Print Array are modular and slide-out interchangeable subassemblies (7). Electronics Modules consist of a metal cabinet (FIG. 7a and FIG. 7b) containing all electronics components of a Print Unit (FIG. 6). The enclosure (FIG. 7a and FIG. 7b) ensures the operator's security and prevents manipulation of delicate elements.

Each Electronics Module is sized to be easily removed from the Print Array by a single operator by pulling from a handle (15). The interchangeability of all Electronics Modules is required to enable this Production Network and improve uptime. Additionally, serviceability is improved by the quick-change and interchangeable nature of the Electronics Module in the Print Array.

Each Electronics Module is equipped with a sliding mounting (7) system. In the preferred embodiment of the present invention, the sliding mounting system consists of two keying elements (13) which fit into T-slotted aluminum profiles (13), allowing modules to slide in and out with ease. Blocking clamps can added including screw clamps, spring clamps, strap clamps, bench clamps, or any other means to secure each module to the Print Array structure (FIG. 2) for stability.

The physical layout of the electrical connections is also a keying element together with its order and arrangement of electrical conductors. The Print Unit module connects to an Electronics Module thanks to a keying element at the end of its cabling bundle (5). In the preferred embodiment of the present invention, the keying element is an industrial 108-pin heavy duty connector for plug socket (5, 12, 15). Each Print Unit (6), Electronics Module (7), Feeding and Drying Module (8) are interchangeable and can be easily removed individually.

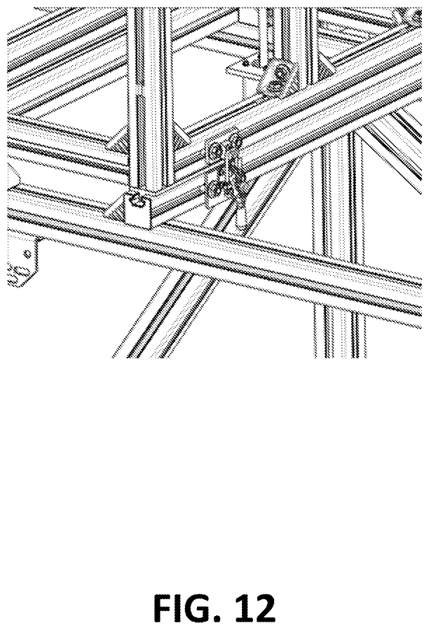

This modular architecture allows fast removal with almost no production downtime. Print Units (FIG. 4) can be conveniently swapped in three steps: i. unlocking the blocking clamps (FIG. 12), ii. sliding out the module (6), iii. unplugging the Print Unit cabling bundle (5) from the 108-pin connector on the rear panel of the Electronics Module (12, 15).

### Electrical Interface

The design of the Electronics Module is used both in the Single Print Units (FIG. 1) model for prototyping and in the Print Array (FIG. 2) product line. Single Print Units (FIG. 3) share the same electronics configuration (4) with each Print Unit (FIG. 4) within the Production Machine. These Electronics Module elements are modular and interchangeable.

The Electronics Module compact metal enclosure (FIG. 7a and FIG. 7b) contains all electronics components to provides power to a Print Unit module. Serviceability is improved by including all electronics elements in the module. This modular architecture includes both mechanical (13) and electrical (5, 12, 15) keying elements that allow quick removal from the Print Array (FIG. 5) with almost no production downtime.

In the preferred embodiment of the present invention, said electrical keying element is an industrial 108-pin heavy-duty connector. Cabling from the Print Unit electronics is organized into a bundle ending in a female 108-pin connector (5), while the male 108-pin connector is in the Electronics Module (12, 15). Electronics Modules can be conveniently swapped in three steps by: i. sliding out the cabinet (7), ii. unplugging the Print Unit cabling bundle (5) from the 108-pin connector on the rear panel of the Electronics Module (12, 15), iii. unplugging the EM's power plug (14).

Each Electronics Module provides power to one Print Unit element components, such as motors, heating system, cooling circuit, air-flow system. It passes through status information and controls switches in the Buffer (31) and material Drying and Feeding System (29). The Electronics Modules (2, 7) sends commands to the Buffer (31) in the Print Array which reports to the Feeding System electronics (30). The Feeding System (FIG. 13) pushes the filament to the Buffer (31) which reports to the Electronics Module (2, 7) filament is available. While pushing status information to the central CPU (34) in the Print Array, it provides control and logic signals, as well as providing and receiving data from sensors in the Print Unit and Drying and Feeding Systems.

### Logical Interface

The design of the Print Array's control architecture enables remote use and control of a mass installation of Print Unit capacity. It is the core of the Production Network. The Print Array distributes control to allow maximum flexibility to manage additive and traditional technologies. The central CPU (34) supports the computing needs of generic APIs for a Production Network.

Offloading these CPU cycles to a non-real-time system is required for precise control of a Production Network. In the present invention, said non-real-time systems are sets composed by the following interchangeable modules: one Print Unit module (6), one Electronics Module (7), and one Feeding and Drying Module (8).

Each set (FIG. 5) of 2×2 interchangeable modules in the Print Array (FIG. 2) do not communicate among each other. Electronics Modules (2) only communicate via handshakes protocols to the Print Unit (1), the Drying and Feeding System (3), and the Buffers (31) in the Feeding System (FIG. 13) within the same set of modules (FIG. 5). Each Electronics Module can send and receive data to and from the Print Array's Internal Router (35).

Each module self-identifies on this Production Network as an individual addressable and controllable print node. Thanks to this logical interface handshake protocol, this node-based 3D printing system creates a new control protocol and sets the foundations for a network-based production, based on a true digital workflow.

The Electronics Module sets global address and type for network, and reads nozzle size for the Print Unit, material type from the material feeding system, and Print Unit's performance offsets. The common logical interface enforced this way also opens up generic APIs to address and control network printers. It also supports RFID, Bluetooth, Bluetooth-LE, IoT interface for logic expansion.

The flexibility of the modular interface between the Print Array Host and the modular and interchangeable Print Units improves serviceability and uptime, which are crucial for scaling up manufacturing. The distributed control grants maximum flexibility to manage both additive and traditional manufacturing, inspection, and scanning technologies. The modular architecture allows economies of scale, by reducing the cost of both production and prototyping modules. This eliminates the gap to adopt and scale up additive manufacturing in high-volume industrial environments, as factories can simply add Production Arrays (FIG. 2) with their Print Units to rapidly meet their growing production demand.

The foregoing describes the preferred embodiment of the invention and sets forth the best mode contemplated for carrying out the invention in such terms as to facilitate the practice of the invention by a person of ordinary skill in the art. However, it is to be understood that the invention has many aspects, is not limited to the structure, processes, methods, and embodiment disclosed and/or claimed, and that equivalents to the disclosed structure, processes, methods, embodiment, and claims are within the scope of the invention as defined by the claims appended hereto or added subsequently.

Although the present invention has been described herein with reference to the foregoing exemplary embodiment, this embodiment does not serve to limit the scope of the present invention. Accordingly, those skilled in the art to which the present invention pertains will appreciate that various modifications and equivalents are possible, without departing from the technical spirit of the present invention.

1. An industrial 3D printing device enabling a scalable Production Network wherein a Print Array Host houses 2×2 or larger sets of modules, each set comprising the following interchangeable elements:
one Print Unit module;
one Electronics Module;
one Feeding and Drying System.

2. The apparatus according to claim 1, wherein said Production Network has a unique interface between the Print Array Host and the interchangeable, removable modules.

3. The apparatus according to claim 1, wherein said interface supports a Production Network of interchangeable, removable Print Units and ancillary modules comprising:
Print Units for engineering materials;
Print Units for high-performance materials;
Electronics Modules;
Material Feeding Systems;
Material Drying Systems;
annealing systems;
vacuum systems;
ultrasonic resin cleaners;
support-material removal systems;
dying, sanding and/or painting systems;
traditional manufacturing equipment;
post-processing automation equipment.

4. The apparatus according to claim 1, wherein modules are designed to slide into a unique physical interface with the Print Array Host.

5. The apparatus according to claim 4, wherein said physical interface comprises the physical layout of the electrical connections as a fast-locking keying element.

6. The apparatus according to claim 4, wherein said physical interface comprises the order and arrangement of electrical conductors in the connection as a fast-locking keying element.

7. The apparatus according to claim 4, wherein said physical interface comprises other physical elements used for keying and identification functions.

8. The apparatus according to claim 4, wherein said physical interface comprises the support and lockdown elements used as fast-locking keying elements.

9. The apparatus according to claim 1, wherein modules have a unique electrical interface with the Print Array Host.

10. The apparatus according to claim 9, wherein said interchangeable, removable Electronics Module receives power from the Print Array Host to power motors and other on-module electronics of the Print Unit it is associated with and physically connected to.

11. The apparatus according to claim 9, wherein said interchangeable, removable Electronics Module provides control and logic signals only to the one Print Unit it is associated with and physically connected to.

12. The apparatus according to claim 9, wherein said interchangeable, removable Electronics Module provides and receives data from sensors in the Print Unit and the Feeding System it is associated with and physically connected to.

13. The apparatus according to claim 9, wherein said interchangeable, removable Electronics Module provides pass-through information to ancillary material handling system it is associated with and physically connected to.

14. The apparatus according to claim 1, wherein said Print Array has an internal CPU supporting all the computing needs including generic APIs for a Production Network.

15. The method wherein the Print Array Host has a unique logic interface with the modules.

16. The method according to claim 15, wherein the internal CPU's cycles are offloaded to each set of modules as a non-real-time system for precise control of the Production Network.

17. The method according to claim 15, wherein each module self-identifies through such logic interface on the Production Network as an individual addressable and controllable print node.

18. The method according to claim 15, wherein each set of modules communicates only with the Print Array Host's CPU but not directly with one another.

19. The method according to claim 15, wherein communication to and from Electronics Modules is established through a handshake protocol:
setting global address;
setting type for network;
reading nozzle size for the Print Unit;
reading material type from the material handling system;
reading machine performance offsets that are stored with each Print Unit.

20. The method according to claim 15, wherein each Electronics Module supports RFID, Bluetooth, Bluetooth-LE, IoT interface for logic expansion.
